(19) United States
(12) Patent Application Publication
(10) Pub. No.: US 2025/0251025 A1
(43) Pub. Date: Aug. 7, 2025

(54) BRAKE DUST COLLECTION SYSTEM

(71) Applicant: ISUZU MOTORS LIMITED, Yokohama-shi (JP)

(72) Inventor: Hikaru ITO, Fujisawa-shi (JP)

(21) Appl. No.: 19/025,383

(22) Filed: Jan. 16, 2025

(30) Foreign Application Priority Data
Feb. 1, 2024 (JP) 2024-013985

(51) Int. Cl. F16D 65/00

(52) U.S. Cl. CPC F16D 65/0031

(57) ABSTRACT

A brake dust collection system includes a covering body that covers a braking device provided to an end portion of each axle of a vehicle, a suction device that suctions dust generated inside the covering body through a suction duct from an opening provided to the covering body, a control device that operates the suction device in a state where the braking device brakes a tire-wheel combination mounted on the end portion of the axle while the vehicle is traveling, and a collection device that is provided between the opening and the suction device in the suction duct and collects the dust suctioned by the suction device.

### CROSS-REFERENCE TO RELATED APPLICATIONS

The present application claims priority to Japanese Patent Application number 2024-013985, filed on Feb. 1, 2024, contents of which are incorporated herein by reference in its entirety.

### BACKGROUND OF THE INVENTION

The present disclosure relates to a charging box of a vehicle that can be charged by an external source.

A vehicle is provided with a charging box that charges a battery by having a charging gun connected thereto (see Japanese Unexamined Patent Application Publication No. 2019-84891). For safety reasons, the charging box is provided with a locking part that locks the charging gun so that the charging gun cannot be disengaged during charging, and the locking part operates upon receiving a control signal from a controller.

Since the brake dust cleaner described above is used while a stopped vehicle is lifted and tires of respective tire-wheel combinations are removed from the vehicle, brake dust cannot be collected while the vehicle is traveling. As a result, there is a problem that brake dust disperses into the atmosphere when the brake is used while the vehicle is traveling.

### BRIEF SUMMARY OF THE INVENTION

The present disclosure focuses on this point, and an object thereof is to suppress dispersion of brake dust while a vehicle is traveling.

A brake dust collection system according to an aspect of the present disclosure includes a covering body that covers a braking device provided to an end portion of each axle of a vehicle, a suction device that suctions dust generated inside the covering body through a suction duct from an opening provided to the covering body, a control device that operates the suction device in a state where the braking device brakes a tire-wheel combination mounted on the end portion of the axle while the vehicle is traveling, and a collection device that is provided between the opening and the suction device in the suction duct and collects the dust suctioned by the suction device.

### BRIEF DESCRIPTION OF THE DRAWINGS

FIG. 1 schematically shows a configuration of a vehicle S according to the present embodiment.

FIG. 2 shows an operation of a control device 17 based on a SOC of a power storage device 16.

FIG. 3 schematically shows the vehicle S that collects brake dust from each axle 7.

FIG. 4 shows an example of a processing sequence in the control device 17.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of Vehicle S

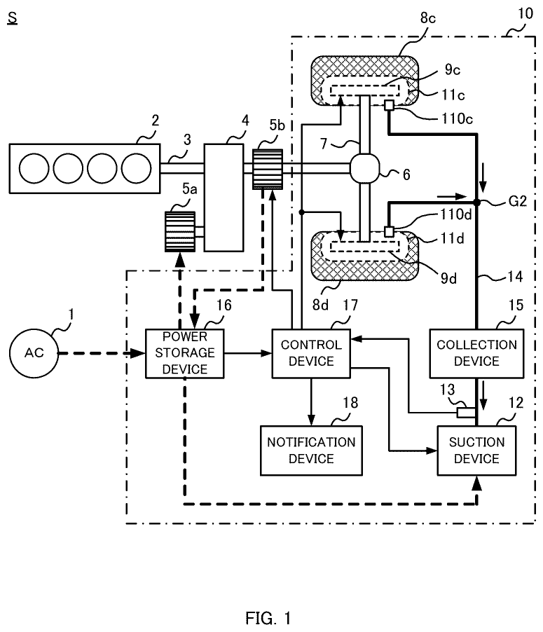

FIG. 1 schematically shows a configuration of a vehicle S according to the present embodiment. The vehicle S shown in FIG. 1 includes a charging port 1, an engine 2, a crankshaft 3, a power transmission device 4, a plurality of motors 5 (a motor 5a and a motor 5b), a final drive 6, an axle 7, a plurality of tire-wheel combinations 8 (a tire-wheel combination 8c and a tire-wheel combination 8d), a plurality of braking devices 9 (a braking device 9c and a braking device 9d), and a brake dust collection system 10. The brake dust collection system 10 includes a plurality of covering bodies 11 (a covering body 11c and a covering body 11d), a suction device 12, a negative pressure sensor 13, a suction duct 14, a collection device 15, a power storage device 16, a control device 17, and a notification device 18.

The vehicle S is an EV (Electric Vehicle) equipped with a drive source that generates power by receiving an electrical supply, and is a Hybrid Electric Vehicle (HEV), a Plug in Hybrid Electric Vehicle (PHEV), or a Battery Electric Vehicle (BEV), for example. In FIG. 1, a PHEV is shown as an example of the vehicle S.

The charging port 1 is an insertion port for supplying electricity to the power storage device 16 from the outside of the vehicle S. As one example, a driver of the vehicle S can stop the vehicle S at a location equipped with a power supply device (a so-called charging station) and connect a tip of a power supply cable included in the power supply device to the charging port 1, thereby charging the power storage device 16 with the electricity outputted from the power supply device.

The engine 2 serves as a drive source of the vehicle S, and is an internal combustion engine that generates power by combusting and expanding a mixture of fuel and intake air. The crankshaft 3 is a shaft for converting reciprocating motion of a piston (not shown in figures) in the engine 2 into rotational motion. The power transmission device 4 is a device (so-called transmission) that converts power generated by the engine 2 and the motor 5 into power suitable for a driving condition of the vehicle S and an operation of a driver, and transmits the power to the final drive 6.

The motor 5 serves as a drive source of the vehicle S, and is an electric motor having a stator and a rotor, for example. The motor 5 generates power by causing the rotor, provided inside the stator, to rotate, and this is achieved by switching the direction of the magnetic field of the stator using electricity supplied from the power storage device 16 via an inverter (not shown in figures), for example. Further, when braking the vehicle S, the motor 5 supplies, to the power storage device 16, electricity generated by the rotor rotating in the direction opposite to the direction of rotation when driving the vehicle S (that is, electricity generated by regenerative braking). Although FIG. 1 shows an operation in which the motor 5a generates power and the motor 5b generates electricity by executing the regenerative braking, the motor 5a and the motor 5b both may generate the power when driving the vehicle S and generate the electricity when braking the vehicle S.

The final drive 6 includes i) a final gear that decelerates the power (rotational speed) received from the power transmission device 4, and ii) a differential gear that converts the power decelerated by the final gear into power (rotational motion) for each tire-wheel combination 8 based on an actual steering angle of the vehicle S. The axle 7 is a shaft that supports the tire-wheel combinations 8 at both ends of the vehicle S in the vehicle width direction. In FIG. 1, the axle 7 is shown as a drive shaft for rotating the tire-wheel combination 8 by the rotational motion received from the final drive 6, but the vehicle S may be provided with other axles 7 different from the drive shaft. The tire-wheel combination 8 is provided at an end portion of the axle 7 in the vehicle width direction of the vehicle S, and includes a wheel that rotates with the rotation of the axle 7 and a tire mounted on an outer circumference of the wheel. If a plurality of axles 7 are provided in the vehicle S, the tire-wheel combinations 8 are respectively provided at the end portions of the axles 7 in the vehicle width direction of the vehicle S, for example.

The braking device 9 is a device that is provided at the end portion of each axle 7 in the vehicle width direction of the vehicle S and brakes the vehicle S by braking the rotation of the axle 7, and is a so-called drum brake or disc brake. If the braking device 9 is a drum brake, the braking device 9 includes a brake shoe which is pressed against the brake drum, and if the braking device 9 is a disc brake, the braking device 9 includes a brake disc which rotates in accordance with the rotation of the axle 7 and a brake pad which presses the brake disc from the vehicle width direction. In the braking device 9, when the brake shoe presses the brake drum or the brake pad presses the brake disc to brake the vehicle S, dust (so-called brake dust) is generated.

The brake dust collection system 10 is a system for collecting brake dust generated when the braking device 9 brakes the traveling vehicle S. In the vehicle S, since the brake dust collection system 10 collects brake dust while the vehicle S is traveling, it is possible to suppress dispersion of the brake dust into the atmosphere.

The configuration and operation of the brake dust collection system 10 will be described in detail below.

### Brake Dust Collection System 10

The covering body 11 is a member for covering the braking device 9 provided at the end portion of the axle 7 of the vehicle S. If the braking device 9 is a drum brake, the covering body 11 may be a brake drum and a back plate included in the drum brake. The covering body 11 confines brake dust generated when the braking device 9 brakes the rotation of the axle 7 within a space surrounded by the covering body 11, thereby suppressing dispersion of the brake dust into the atmosphere. Although the covering body 11 is provided to each braking device 9 provided in the vehicle S, the covering body 11c covering the braking device 9c and the covering body 11d covering the braking device 9d among the plurality of covering bodies 11 provided in the vehicle S are shown in FIG. 1 for simplicity of description.

Each covering body 11 is provided with an opening 110 (an opening 110c and an opening 110d in FIG. 1). The opening 110 is provided on the outer peripheral surface of the covering body 11 or a portion of the covering body 11 facing the center of the vehicle S in the vehicle width direction, for example. The opening 110 is provided in this manner, and so the suction duct 14 can be provided so as not to come into contact with the tire-wheel combination 8 in the brake dust collection system 10.

The suction device 12 suctions the brake dust generated inside the covering body 11 from the opening 110 provided to the covering body 11 via the suction duct 14. The suction device 12 operates on the basis of the electricity stored in the power storage device 16, for example. As an example, the suction device 12 includes a motor equipped with a fan and generates a negative pressure (a pressure difference between the inside and the outside of the suction device 12) by causing the motor to perform rotation using the electricity supplied by the power storage device 16, thereby expelling air to the outside of the suction device 12. As another example, the suction device 12 includes a pump and generates a negative pressure by operating the pump using the electricity supplied from the power storage device 16 to expel air to the outside of the suction device 12. The suction device 12 suctions the brake dust contained in the air by suctioning the air from the space surrounded by the covering body 11 using the generated negative pressure.

The negative pressure sensor 13 is a sensor for detecting the negative pressure generated by the suction device 12, and outputs the detected negative pressure to the control device 17 at a predetermined control cycle. The predetermined control cycle is one second, for example. The suction duct 14 is a flow path through which air containing brake dust flows as the suction device 12 suctions brake dust from each covering body 11. The suction duct 14 includes a branch duct through which air flows from the opening 110 provided to each covering body 11 to a junction point G2, and a junction duct through which air flows from the junction point G2 to the suction device 12. FIG. 1 shows i) a first branch duct through which air flows from the opening 110c to the junction point G2, ii) a second branch duct through which air flows from the opening 110d to the junction point G2, and iii) a junction duct through which air flows from the junction point G2 to the suction device 12. The collection device 15 is provided downstream of the junction point G2 and upstream of the suction device 12, in the junction duct.

The collection device 15 is provided downstream of the opening 110 in the suction duct 14 between the suction device 12 and the junction point G2, and collects the brake dust suctioned by the suction device 12. The collection device 15 includes a filter for collecting brake dust, for example, and collects the brake dust as the suction device 12 performs suction, which causes the brake dust contained in the air flowing through the suction duct 14 to adhere to the filter.

The power storage device 16 includes a rechargeable storage battery, for example, and supplies electricity to the motor 5 (the motor 5a in FIG. 1) and the suction device 12. The power storage device 16, for example, charges with the electricity generated by the motor 5 (a motor 5b in FIG. 1) executing the regenerative braking when braking the vehicle S. The power storage device 16 may charge with the electricity supplied from an external power supply device through the charging port 1. The power storage device 16 outputs a charge state of the storage battery to the control device 17 at a predetermined control cycle. It should be noted that, in the following description, the charge state of the storage battery included in the power storage device 16 is referred to as a SOC (State Of Charge), and the SOC of the storage battery is referred to as the SOC of the power storage device 16.

The control device 17 is a device including one or more processors such as a Central Processing Unit (CPU) or an Electronic Control Unit (ECU), for example. The control device 17 executes a braking process for braking the vehicle S and a process for operating the suction device 12 for collecting brake dust generated through the braking process, for example. The control device 17 may have a housing including an electronic component, or may be a printed circuit board on which an electronic component is mounted.

The control device 17 operates the suction device 12 in a state where the braking device 9 brakes the tire-wheel combination 8 mounted on the end portion of the axle 7 while the vehicle S is traveling. For example, the control device 17 operates the suction device 12, for example, upon receiving that the driver of the vehicle S has operated the brake pedal while the vehicle S is traveling. For example, if a depression amount of the brake pedal installed in the vehicle S is greater than a predetermined depression amount, the control device 17 operates the suction device 12. As one example, if the depression amount of the brake pedal detected by a brake pedal sensor (not shown in figures) equipped by the vehicle S is greater than the predetermined depression amount, the control device 17 operates the suction device 12. The predetermined depression amount is a depression amount determined through experiments or simulations. The predetermined depression amount may be 0.

The control device 17 operates in this manner, and so the control device 17 can collect brake dust generated during braking the vehicle S at the timing when the vehicle S is being braked. As a result, the brake dust collection system 10 can suppress dispersion of the brake dust, generated while the vehicle S is traveling, into the atmosphere.

The control device 17, for example, stops the suction device 12 upon receiving that the driver of the vehicle S has ended the operation of the brake pedal. As one example, the control device 17 stops the suction device 12 if the depression amount of the brake pedal detected by the brake pedal sensor is equal to or less than the predetermined depression amount.

The control device 17 executes, as a braking process for braking the vehicle S, at least one of i) a mechanical braking process for braking the tire-wheel combination 8 using the braking device 9 (first braking process) and ii) a regenerative braking process for braking the tire-wheel combination 8 using the motor 5 that rotates the axle 7 (second braking process). If the vehicle S is braked by the mechanical braking process, the braking device 9 generates brake dust. However, if the vehicle S is braked by the regenerative braking process, the braking device 9 does not generate brake dust. Therefore, the control device 17 operates the suction device 12 when, for example, executing the mechanical braking process from among the mechanical braking process and the regenerative braking process.

If it is determined that the braking force corresponding to an operation amount of the brake pedal operated by the driver of the vehicle S can be generated by the regenerative braking process, for example, the control device 17 executes the regenerative braking process and does not operate the suction device 12. If that braking force is greater than the maximum value of the braking force that can be generated by the regenerative brake, for example, the control device 17 i) executes the regenerative braking process and the mechanical braking process or ii) executes the mechanical braking process and operates the suction device 12.

The control device 17 operates as described above, and so the control device 17 can operate the suction device 12 only at the timing when the braking device 9 generates brake dust, thereby collecting brake dust at an appropriate timing. As a result, the controller 17 can prevent the SOC of the power storage device 16, which supplies electricity to the suction device 12, from dropping excessively while the vehicle S is traveling.

In order for the power storage device 16 to charge and discharge a predetermined amount of electricity over a predetermined durability period, it is desirable to charge and discharge the power storage device 16 so that its SOC remains within a predetermined range (for example, 30% or more and less than 80%). Further, the power storage device 16 discharges (supplies power) to the suction device 12 if the control device 17, when executing the mechanical braking process, operates the suction device 12, and charges with the electricity generated by the motor 5 if the control device 17 executes the regenerative braking process. Therefore, the control device 17, for example, i) determines a process to be executed among the mechanical braking process and the regenerative braking process on the basis of the SOC acquired from the power storage device 16 and ii) determines whether or not to operate the suction device 12 on the basis of that process.

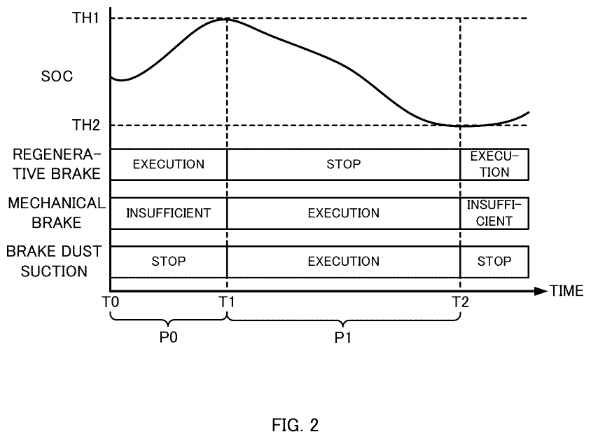

FIG. 2 shows an operation of the control device 17 based on the SOC of the power storage device 16. The horizontal axis of FIG. 2 indicates time. The vertical axis of FIG. 2 indicates i) “SOC” representing the SOC of the power storage device 16, ii) “regenerative brake” representing whether or not the regenerative braking process is executed, iii) “mechanical brake” representing whether or not the mechanical braking process is executed, and iv) “brake dust suction” representing whether or not the suction device 12 is operated. In FIG. 2, “TH1” represents a first threshold value (for example, 80%) of the SOC, and “TH2” indicates a second threshold value (for example, 30%) of the SOC. In FIG. 2, i) “execution” represents that, when the driver executes an operation for braking the vehicle S, the control device 17 executes a process corresponding to that operation, ii) “insufficient” represents that the control device 17 executes the mechanical braking process if the braking force needed for braking the vehicle S is insufficient, and iii) “stop” represents that the control device 17 does not execute any process.

For example, when braking the vehicle S, the control device 17 executes the regenerative braking process with the suction device 12 stopped if the SOC of the power storage device 16, which stores the electricity generated by the motor 5, is below the threshold value TH1. For example, when braking the vehicle S at time P0 shown in FIG. 2, the control device 17 determines that the SOC acquired from the power storage device 16 is below TH1. The control device 17 then specifies the braking force corresponding to the depression amount of the brake pedal operated by the driver of the vehicle S, and generates that braking force by executing the regenerative braking process with the suction device 12 stopped, for example.

The control device 17 operates as described above, and so the control device 17 can improve the SOC of the power storage device 16 by executing the regenerative braking process to brake the vehicle S if the SOC of the power storage device 16 is low. As a result, the control device 17 can suppress deterioration of the power storage device 16. It should be noted that, at the time P0 shown in FIG. 2, if the specified braking force is greater than the maximum value of the braking force that can be generated by the regenerative braking process, the control device 17 may execute both the regenerative braking process and the mechanical braking process with the suction device 12 operated.

When braking the vehicle S, the control device 17, for example, executes the mechanical braking process and operates the suction device 12 if the SOC, after reaching the threshold value TH1, is equal to or above the threshold value TH2 that is lower than the threshold value TH1. For example, when braking the vehicle S at the time P1 shown in FIG. 2, the control device 17 determines that the SOC is equal to or greater than the threshold value TH2 at the current time included in the time P1 after the SOC reaches the threshold value TH1 at the time T1. The control device 17 then specifies the braking force corresponding to the depression amount of the brake pedal operated by the driver of the vehicle S, and generates that braking force by executing the mechanical braking process and operates the suction device 12, for example.

The control device 17 operates as described above, and so the control device 17 can lower the SOC by operating the suction device 12 when braking the vehicle S and collect the brake dust resulting from the execution of the mechanical braking process. As a result, the control device 17 can suppress deterioration of the power storage device 16 as well as dispersion of brake dust while the vehicle S is traveling.

Returning to FIG. 1, the notification device 18 is a device for notifying the driver of the vehicle S whether or not the brake dust collection system 10 is in an abnormal condition. The abnormal condition refers to, for example, a state where brake dust adheres to the filter of the collection device 15, resulting in clogging of the filter and causing the suction device 12 to experience difficulty in suctioning air from the covering body 11. The notification device 18 notifies the driver of the vehicle S of the abnormality in the collection device 15, for example, if the control device 17 determines that a negative pressure of the suction device 12 detected by the negative pressure sensor 13 is equal to or greater than a predetermined negative pressure. The predetermined negative pressure is a negative pressure determined through experiments or simulations.

The notification device 18, for example, displays a warning image indicating that the collection device 15 is in the abnormal condition on an instrument panel (not shown in figures) equipped with the vehicle S upon receiving negative pressure information from the control device 17 indicating that the negative pressure of the suction device 12 is equal to or higher than the predetermined negative pressure. The warning image includes an icon image or text data recommending, for example, replacement or cleaning of the filter of the collection device 15. The notification device 18 may output a warning sound indicating that the collection device 15 is in the abnormal condition from a speaker (not shown in figures) equipped by the vehicle S upon receiving the negative pressure information from the control device 17 indicating that the negative pressure of the suction device 12 is equal to or higher than the predetermined negative pressure.

The notification device 18 executes a process of hiding the displayed warning image or does not execute a process of displaying the warning image upon receiving the negative pressure information from the control device 17 indicating that the negative pressure of the suction device 12 is less than the predetermined negative pressure, for example. The notification device 18 may execute a process of stopping the warning sound being outputted or may not execute a process of outputting the warning sound upon receiving the negative pressure information from the control device 17 indicating that the negative pressure of the suction device 12 is less than the predetermined negative pressure. The notification device 18 operates as described above, the notification device 18 can notify the driver of the vehicle S of replacement or cleaning of the filter included in the collection device 15 at an appropriate timing.

In FIG. 1, the axle 7, which is a drive shaft included in the vehicle S, is shown as an example of the axle 7, but the vehicle S may further include one or more other axles 7. In this case, the tire-wheel combination 8, the braking device 9, and the covering body 11 are provided at the end portion of each axle 7. The axle 7 provided at the front in the longitudinal direction of the vehicle S (hereinafter referred to as a “front axle”) bears a greater load during braking of the vehicle S than the axle 7 provided at the rear in the longitudinal direction of the vehicle S (hereinafter referred to as a “rear axle”). Therefore, the braking device 9 provided to the front axle generates a greater amount of brake dust when braking the vehicle S than the braking device 9 provided to the rear axle.

Accordingly, in the brake dust collection system 10, the suction device 12, the suction duct 14, and the collection device 15 may be provided for each of the front axle and the rear axle. And, the brake dust collection system 10 may cause the suction device 12 to generate a suction force corresponding to the amount of brake dust in each of the front axle and the rear axle, or may attach a filter having a size corresponding to the amount of brake dust to the collection device 15.

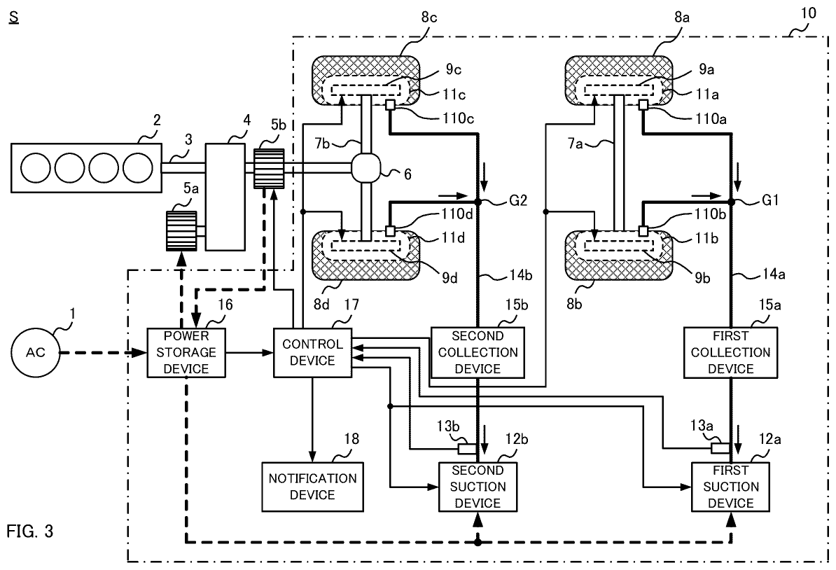

FIG. 3 schematically shows the vehicle S that collects brake dust from each axle 7. The vehicle S shown in FIG. 3 is different from the vehicle S shown in FIG. 1 in that it includes a front axle 7a, a tire-wheel combination 8a, a tire-wheel combination 8b, a braking device 9a, a braking device 9b, a covering body 11a, a covering body 11b, a first suction device 12a, a first negative pressure sensor 13a, a first suction duct 14a, and a first collection device 15a, and is the same in other respects. A rear axle 7b shown in FIG. 3 is the same as the axle 7 shown in FIG. 1, a second suction device 12b shown in FIG. 3 is the same as the suction device 12 shown in FIG. 1, a second negative pressure sensor 13b shown in FIG. 3 is the same as the negative pressure sensor 13 shown in FIG. 1, a second suction duct 14b shown in FIG. 3 is the same as the suction duct 14 shown in FIG. 1, and a second collection device 15b shown in FIG. 3 is the same as the same as the collection device 15 shown in FIG. 1. An opening 110a is provided to the covering body 11a and an opening 110b is provided to the covering body 11b, shown in FIG. 3.

As shown in FIG. 3, the brake dust collection system 10 includes the first suction device 12a and the second suction device 12b as the suction device 12, for example. The first suction device 12a is a device that suctions brake dust generated inside the covering body 11a and the covering body 11b provided to the front axle 7a of the vehicle S through the first suction duct 14a, for example. The second suction device 12b is a device that suctions brake dust generated inside the covering body 11c and the covering body 11d provided to the rear axle 7b of the vehicle S through the second suction duct 14b, for example. The first suction device 12a suctions brake dust with a suction force greater than the suction force with which the second suction device 12b suctions brake dust.

The brake dust collection system 10 operates in this manner, and so the suction device 12 can increase the suction force for suctioning air containing brake dust from the covering body 11 covering the braking device 9 applied with a greater load for braking the vehicle S among the plurality of braking devices 9 included in the vehicle S. As a result, the greater the amount of brake dust in the air, the more the suction force can be increased, allowing the brake dust to be effectively collected.

The brake dust collection system 10 includes the first collection device 15a and the second collection device 15b as the collection device 15, for example. The first collection device 15a is, for example, a device that is provided between the junction point G1 and the first suction device 12a in the first suction duct 14a and collects the brake dust suctioned from the inside of the covering body 11a and the covering body 11b provided to the front axle 7a of the vehicle S. The second collection device 15b is, for example, a device that is provided between the junction point G2 and the second suction device 12b in the second suction duct 14b and collects the brake dust suctioned from the inside of the covering body 11c and the covering body 11d provided to the rear axle 7b of the vehicle S. And, the first collection device 15a is attached with a filter for collecting brake dust which is larger than a filter attached to the second collection device 15b. Since the amount of brake dust sucked from inside the covering body 11a and the covering body 11b is greater than the amount of brake dust sucked from inside the covering body 11c and the covering body 11d, the brake dust collection system 10 can attach a filter having an adsorption capacity corresponding to the amount of brake dust to the collecting device 15 by making the size of the filter attached to the first collection device 15a larger than the size of the filter attached to the second collection device 15b. As a result, the brake dust collection system 10 can bring closer the timing at which a negative pressure increase due to clogging occurs in each filter.

The notification device 18 notifies the driver of the vehicle S of the abnormality in the first collection device 15a if a negative pressure detected by the first negative pressure sensor 13a is equal to or higher than the predetermined negative pressure. The notification device 18 notifies the driver of the vehicle S of the abnormality in the second collection device 15b if s negative pressure detected by the second negative pressure sensor 13b is equal to or higher than the predetermined negative pressure. For example, the notification device 18 displays a first warning image indicating that the abnormality in the first collection device 15a on the instrument panel if the negative pressure of the first suction device 12a detected by the first negative pressure sensor 13a is equal to or higher than the predetermined negative pressure. For example, the notification device 18 displays a second warning image indicating that the abnormality in the second collection device 15b on the instrument panel if the negative pressure of the second suction device 12b detected by the second negative pressure sensor 13b is equal to or higher than the predetermined negative pressure.

In the brake dust collection system 10, the timing at which a negative pressure increase due to clogging occurs in each filter can be brought closer. Therefore, when the notification device 18 notifies the driver of the need for replacement or cleaning of each filter individually, the timing of such notifications for each filter can also be brought closer. Specifically, in the brake dust collection system 10, it is possible to bring closer a) the timing at which the negative pressure increase due to clogging occurs in the filter mounted on the collection device 15a and b) the timing at which the negative pressure increase due to clogging occurs in the filter mounted on the collection device 15b, so that it is also possible to bring closer c) the timing to notify about the need to replace or clean the filter mounted on the collection device 15a and d) the timing to notify about the need to replace or clean the filter mounted on the collection device 15b. Thus, it facilitates the driver to replace or clean the filters at the same timing. It should be noted that, in the brake dust collection system 10, even if the vehicle S includes a plurality of axles 7, brake dust may be collected by using a single suction device 12 and a single collection device 15.

### Processing Sequence in Control Device 17

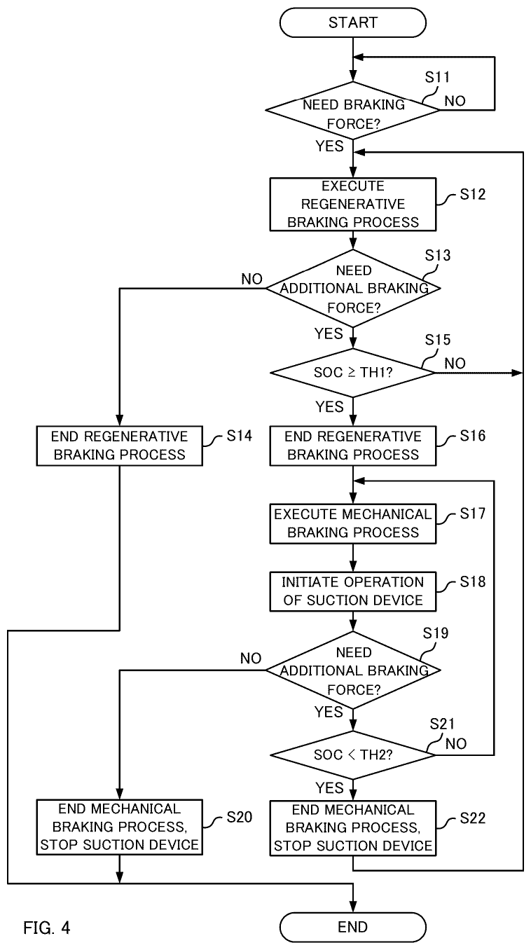

FIG. 4 shows an example of a processing sequence in the control device 17. The processing sequence shown in FIG. 4 shows an operation for braking the vehicle S by the control device 17, shown in FIG. 1, executing at least one of the mechanical braking process and the regenerative braking process. The processing sequence shown in FIG. 4 starts when the vehicle S is traveling at a time included in the time P0 shown in FIG. 2.

The control device 17 determines whether or not the braking force for braking the vehicle S is necessary (S11). For example, the control device 17 i) determines that the braking force is necessary if the depression amount detected by the brake pedal sensor is greater than 0 at the time when step S11 is executed, and ii) determines that no braking force is necessary if that depression amount is 0 at the time when step S11 is executed. If it is determined that no braking force is necessary (NO in S11), the control device 17 repeats step S11. If it is determined that the braking force is necessary (YES in S11), the control device 17 starts the execution of the regenerative braking process (S12).

Subsequently, the control device 17 determines whether or not additional braking force is necessary (S13). For example, the control device 17 i) determines that the additional braking force is necessary if the depression amount detected by the brake pedal sensor is greater than 0 at the time when step S13 is executed, and ii) determines that no additional braking force is necessary if that depression amount is 0 at the time when step S13 is executed. If it is determined that no additional braking force is necessary (NO in S13), the control device 17 ends the regenerative braking process (S14), and ends the processing shown in FIG. 4. If it is determined that the additional braking force is necessary (YES in S13), the control device 17 determines whether or not the SOC of the power storage device 16 is equal to or greater than the threshold value TH1 (S15).

If the SOC of the power storage device 16 is less than the threshold value TH1 (NO in S15), the control device 17 returns to step S12 and continues the execution of the regenerative braking process. If the SOC of the power storage device 16 is equal to or greater than the threshold value TH1 (YES in S15), the control device 17 ends the regenerative braking process (S16), starts the execution of the mechanical braking process (S17), and operates the suction device 12 (S18).

Subsequently, the control device 17 determines whether or not additional braking force is required (S19). For example, the control device 17 i) determines that the additional braking force is necessary if the depression amount detected by the brake pedal sensor is larger than 0 at the time when step S19 is executed, and ii) determines that the no additional braking force is necessary if that depression amount is 0 at the time when step S19 is executed. If it is determined that no additional braking force is necessary (NO in S19), the control device 17 ends the mechanical braking process and stops the suction device 12 (S20). Then, the control device 17 ends the process shown in FIG. 4. If it is determined that the additional braking force is necessary (YES in S19), the control device 17 determines whether or not the SOC of the power storage device 16 is less than the threshold value TH2 (S21).

If the SOC of the power storage device 16 is equal to or higher than the threshold value TH2 (NO in S21), the control device 17 returns to step S17 and continues the execution of the mechanical braking process. If the SOC of the power storage device 16 is less than the threshold value TH2 (YES in S21), the control device 17 ends the mechanical braking process and stops the suction device 12 (S22). Then, the control device 17 returns to step S12 and starts the execution of the regenerative braking process.

### Effects of Brake Dust Collection System 10

As described above, the brake dust collection system 10 includes i) the covering body 11 for covering the braking device 9 provided at the end portion of the axle 7 of the vehicle S, ii) the suction device 12 for suctioning the brake dust generated inside the covering body 11 from the opening 110 provided to the covering body 11 via the suction duct 14, iii) the control device 17 for operating the suction device 12 in a state where the braking device 9 brakes the tire-wheel combination 8 mounted at the end portion of the axle 7 while the vehicle S is traveling, and iv) the collection device 15 that is provided between the opening 110 and the suction device 12 in the suction duct 14 and collects the brake dust suctioned by the suction device 12.

Since the brake dust collection system 10 is configured as described above, the brake dust collection system 10 can confine the brake dust, generated by the braking device 9 when braking the traveling vehicle S, in a space surrounded by the covering body 11. In the brake dust collection system 10, the suction device 12 suctions the brake dust from the opening 110 provided to the covering body 11 when the vehicle S is braked, so that the collection device 15 can collect the brake dust while the vehicle S is traveling. As a result, the brake dust collection system 10 can suppress dispersion of the brake dust while the vehicle S is traveling.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A brake dust collection system comprising:
a covering body that covers a braking device provided to an end portion of each axle of a vehicle;
a suction device that suctions dust generated inside the covering body through a suction duct from an opening provided to the covering body;
a control device that operates the suction device in a state where the braking device brakes a tire-wheel combination mounted on the end portion of the axle while the vehicle is traveling; and
a collection device that is provided between the opening and the suction device in the suction duct and collects the dust suctioned by the suction device.

2. The brake dust collection system according to claim 1, wherein
the control device operates the suction device when executing a first braking process from among the first braking process for braking the tire-wheel combination using the braking device and a second braking process for braking the tire-wheel combination using a motor that rotates the axle.

3. The brake dust collection system according to claim 2, wherein
the control device executes the second braking process with the suction device stopped if a charge state of a power storage device, which stores electricity generated by the motor, is less than a first threshold value.

4. The brake dust collection system according to claim 3, wherein
the control device executes the first braking process and operates the suction device if the charge state, after reaching the first threshold value, is equal to or greater than a second threshold value that is lower than the first threshold value.

5. The brake dust collection system according to claim 4, wherein
the suction device is driven by being supplied with electricity stored in the power storage device.

6. The brake dust collection system according to claim 1, further comprising:
a notification device that notifies a driver of the vehicle of an abnormality in the collection device if a negative pressure of the suction device is equal to or greater than a predetermined negative pressure.

7. The brake dust collection system according to claim 1, wherein
the opening is provided to an outer peripheral surface of the covering body or a portion of the covering body facing a center of the vehicle in a vehicle width direction.

8. The brake dust collection system according to claim 1, comprising:
a first collection device that collects the dust suctioned from an inside of the covering body provided to a front axle of the vehicle and a second collection device that collects the dust suctioned from the inside of the covering body provided to a rear axle of the vehicle, as a plurality of the collection devices; wherein
a size of a filter that the first collection device has for collecting the dust is larger than a size of the filter that the second collection device has.

9. The brake dust collection system according to claim 1, comprising:
a first suction device that suctions the dust generated inside the covering body provided to a front axle of the vehicle and a second suction device that suctions the dust generated inside the covering body provided to a rear axle of the vehicle, as a plurality of one or more suction devices,
wherein a suction force with which the first suction device suctions the dust is greater than a suction force with which the second suction device suctions the dust.

10. The brake dust collection system according to claim 1, wherein
the control device operates the suction device if a depression amount of a brake pedal included in the vehicle is greater than a predetermined depression amount.

11. The brake dust collection system according to claim 2, wherein
the control device executes i) the first braking process and the second braking process or ii) the first braking process and operates the suction device, if braking force corresponding to a depression amount of a brake pedal included in the vehicle is greater than a maximum value of a braking force resulting from the second braking process.
